(19) United States
(12) Patent Application Publication
(10) Pub. No.: US 2009/0221809 A1
(43) Pub. Date: Sep. 3, 2009

(54) METHOD FOR THE SORPTION OF AT LEAST ONE NUCLEIC ACID-ACTIVATED PHYLLOSILICATES

(75) Inventors: Ulrich Sohling, Freising (DE); Thomas Scheper, Hannover (DE); Kasper Cornelia, Hannover (DE); Kirstin Suck, Muenchen (DE); Daniel Riechers, Hannover (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: SUD-CHEMIE AG, Munchen (DE)

(21) Appl. No.: 12/096,402

(22) PCT Filed: Dec. 9, 2005
(86) PCT No.: PCT/EP2005/013236

§ 371 Date: Aug. 22, 2008

(51) Int. Cl. C07H 1/06; B01J 20/22

(52) U.S. Cl. 536/25.4; 502/401

(57) ABSTRACT

The invention relates to a method for the sorption of at least one nucleic acid molecule from a liquid medium, comprising the following steps: (a) providing a liquid medium comprising at least one nucleic acid molecule; (b) providing a layer comprising at least one acid-activated phyllosilicate, where the layer is permeable by the liquid medium, and the layer thickness is at least 1 mm; (c) passing the liquid medium with the at least one nucleic acid molecule from step (a) through the layer from step (b) for sorption of the at least one nucleic acid molecule in the layer.

The invention relate to a method for the sorption of at least one nucleic acid molecule from a liquid medium using a layer which includes at least one acid-activated phyllosilicate. The method can be used in particular for enriching, depleting, removing, recovering or fractionating nucleic acid molecules from or in liquid media.

The industrial and scientific importance of the separation and purification of biomolecules is continually increasing. Thus, separation processes for purifying or depleting DNA are important on the one hand for fundamental research, where genetic material must for example be isolated and purified, in order to generate genetically modified organisms. This is, however, also currently being increasingly used industrially. Thus, some of the active ingredients used in medicine are already produced by genetic manipulation.

A further field of application of such separation processes, and the adsorbents employed therefor, is represented by the depletion of DNA in wastewaters, especially associated with production processes with genetically modified organisms such as, for example, bacteria or fungi.

A large number of adsorbents are already known in the state of the art, especially those based on silanized silicate particles (silica gel) or functionalized celluloses.

U.S. Pat. No. 4,029,583 describes a silica gel chromatographic support material suitable for separating proteins, peptides and nucleic acids, which has a cavity diameter of up to 50 nm, and to which is linked by means of a silanizing reagent a stationary phase having anion or cation exchanger-forming groups which interact with the substances to be separated. The silanized silica gel is brought into contact with water, entailing the risk of the stationary phase polymerizing and the pores of the support material closing.

According to EP-B 0 104 210, nucleic acid mixtures can be fractionated into their constituents with high resolution and at a high flow rate on use of a chromatographic support material in which the diameter of the cavities amounts to one to twenty times the largest dimension of the nucleic acid to be isolated in each case or the largest dimension of the largest of all the nucleic acids present in the mixture. The chromatographic support material is produced by initially reacting it with a silanizing reagent which has a flexible chain group which in turn is converted by reaction with an anion or cation exchanger-forming reagent to the finished support material.

EP 0 496 822 (WO 91/05606, DE 393 50 98) describes a chromatographic support material whose cavities have one to twenty times the size of the largest dimension of the nucleic acids to be separated, which can be obtained by reacting a starting support material with a cavity size of from 10 to 1000 nm, a specific surface area of from 5 to 800 m²/g and a particle size of from 3 to 500 μm with a silanizing reagent which is characterized in that the silanizing reagent has at least one reactive group already reacted with a primary or secondary hydroxyalkylamine or comprises a reactive group, such as an epoxy group or halogen atoms, which can be reacted with a hydroxyalkylamine and which, in a further reaction stage, is reacted with a hydroxyalkylamine.

The article by T. G. Lawson et al., “Separation of synthetic oligonucleotides on columns of microparticulate”, Analytical Biochemistry (1983), 133(1), 85-93, describes the separation of synthetic oligonucleotides on columns based on micro-particulate silicon dioxide or silica gel which has been coated with crosslinked polyethyleneimine. The coating was in this case achieved by pumping the polyethyleneimine solution through the silica gel column. The method described in this article can be employed only for small amounts. In addition, this article refers only to polyethyleneimine-modified silica gel particles.

Further adsorbent systems are described in US 2003003272, EP 1 162 459 and EP 281 390. The article “Nukleinsäure-aufreinigung durch Kationen-Komplexierung” [Nucleic acid purification by cation complexing] by Prof. Michael Lorenz, Molzym GmbH & Co. KG, Bremen in Laborwelt No. 4/2003, page 40, describes a novel method for purifying nucleic acids with specific mini spin columns. According to the statements in the article, these are based on a matrix in which a clay mineral has been mixed with sand. Nothing is said about the nature of the clay minerals.

It is a disadvantage of the prior art sorption systems that they either are relatively costly or do not comply with requirements in the binding capacity, the kinetics of binding and/or the rate of recovery of the absorbed nucleic acid(s). Because of the increasing importance of the separation or purification of nucleic acids from various media, there is a continuing demand for improved sorbents for nucleic acids.

One object of the present invention was therefore to provide an improved method for the sorption of nucleic acids which can be employed efficiently and simply for enriching or depleting, for removing or recovering, or for fractionating nucleic acids and avoids the prior art disadvantages.

It has now astonishingly been found that to achieve this object it is possible particularly advantageously to use sorbents which include at least one acid-activated phyllosilicate. Such acid-activated phyllosilicates show a surprisingly high binding capacity for nucleic acids which even exceeds that of commercial prior art adsorption systems. They additionally show particularly rapid kinetics of binding. An additional advantage is that the bound nucleic acid can be removed virtually quantitatively again from the sorbent.

It has further been found that the acid-activated phyllosilicate used according to the invention as sorbent can be employed particularly advantageously for the sorption of at least one nucleic acid molecule from a liquid medium when it is present in a layer with a layer thickness of at least one millimeter. For the sorption, the liquid medium with the at least one nucleic acid molecule can then be passed through the layer comprising the at least one acid-activated phyllosilicate.

One aspect of the present invention thus relates to a method for the sorption of at least one nucleic acid molecule from a liquid medium, comprising the following steps:

a. providing a liquid medium comprising at least one nucleic acid molecule;
b. providing a layer comprising at least one acid-activated phyllosilicate, where the layer is permeable by the liquid medium, and the layer thickness is at least 1 mm;
c. passing the liquid medium with the at least one nucleic acid molecule from step a. through the layer from step b. for sorption of the at least one nucleic acid molecule in the layer.

In the method of the invention therefore the liquid medium with the at least one nucleic acid molecule is passed through the layer comprising the at least one acid-activated phyllosilicate. This passing through can take place in any way. In many cases, capillary forces or gravity will suffice to cause the liquid medium with the at least one nucleic acid molecule to flow through the layer with the acid-activated phyllosilicate. It is also possible where appropriate to apply pressure in order to enable or expedite the passing of the liquid medium through the layer, depending on the viscosity of the liquid medium comprising the at least one nucleic acid molecule. It is equally possible to apply a reduced pressure or vacuum underneath the layer, so that the liquid medium with the at least one nucleic acid molecule is sucked through the layer with the acid-activated phyllosilicate. The skilled worker can thus also easily make routine adjustments to the desired rate of passing through, depending on the liquid medium used. While the liquid medium with the at least one nucleic acid molecule is being passed through it can undergo sorption in the layer with the acid-activated phyllosilicate.

The sorbents disclosed herein are thus both suitable for fractionating nucleic acids and for enriching or depleting them, for recovering or removing them, from appropriate solutions/media. The almost quantitative recovery rate on elution with customary, normally high salt-content buffers shows that it is also possible to recover the bound nucleic acid again. Preferred elution buffers have a pH of 8 or more. The areas of use of such sorbents are diverse. Without this invention being restricted to the following examples, some possible applications are to be mentioned: it is conceivable for example to separate nucleic acids from a multicomponent mixture or to deplete DNA from wastewaters from biotechnological production residues with genetically modified organisms. It is possible in general for the sorbent and method of the invention also to be employed for all molecular biological, microbiological or biotechnological methods in connection with nucleic acids, especially the enrichment or depletion, fractionation, transient or permanent immobilization or other utilization thereof. Examples of methods and processes are to be found in relevant textbooks such as Sambrook et al., “Molecular Cloning: A Laboratory Manual”, Cold Spring Harbour Press 2001 and are familiar to the skilled worker. The present method can also be employed in the context of chromatographic fractionation of nucleic acids. Nucleic acids mean in this connection primarily DNA and RNA species, inclusive of genomic DNA and cDNA and fragments thereof, mRNA, tRNA, rRNA and further nucleic acid derivatives of natural or synthetic origin of a desired length.

The method of the invention is, however, also suitable in principle for separating or purifying proteins and other biomolecules. Biomolecule means in the context of the present invention a molecule which includes as building blocks nucleotides or nucleosides (nucleobases), amino acids, monosaccharides and/or fatty acids. According to one aspect of the present invention, reference in the description to “nucleic acid (molecule)” thus also includes other biomolecules. However, the use for the sorption of nucleic acids is particularly preferred.

Starting materials which can be used for the phyllosilicates employed according to the invention are all natural or synthetic phyllosilicates or mixtures thereof which can be activated by an acid, i.e. in which cations in the intermediate layers can be replaced by protons. Two- and in particular three-layer silicates are preferred. Acid-activatable phyllosilicates are familiar to the skilled worker and include in particular the smectic or montmorillonite-containing phyllosilicates such as bentonite. It is generally possible to use both so-called naturally active and non-naturally active phyllosilicates, especially di- and trioctahedral phyllosilicates of the serpentine, kaolin and talc-pyrophylite group, smectites, vermiculites, illites and chlorites, and those of the sepiolite-palygorskite group such as, for example, montmorillonite, natronite, saponite and vermiculite or hectorite, beidellite, palygorskite, and mixed layer minerals. It is of course also possible to employ mixtures of two or more of the above materials. A further possibility is for the phyllosilicate employed according to the invention also to comprise further constituents (also for example non-acid-activated phyllosilicates) which do not impair the intended use of the acid-activated clay, especially its sorption capacity, or in fact have useful properties.

Particularly preferred phyllosilicates are those of the montmorillonite/beidellite series such as, for example, montmorillonite, bentonite, natronite, saponite and hectorite. Bentonites are most preferred because in this case surprisingly particularly advantageous binding capacities and kinetics of binding for nucleic acids are achieved.

It has also been found in the context of the present invention that acid-activated phyllosilicates which can particularly advantageously be used in the method of the invention are those having an iron content, calculated as Fe₂O₃, based on the total amount of acid-activated phyllosilicate employed, of less than 6% by weight, preferably less than 4% by weight, more preferably less than 3% by weight, in particular less than 2.5% by weight. It has thus been found that a particularly mild and deficient sorption or purification of the nucleic acid molecules is possible on use of such an acid-activated phyllosilicate with low iron content. It is assumed, without the invention being confined to the assumption of this theoretical mechanism, that unwanted redox reactions which might be catalyzed by iron are avoided through the low iron impurities in the acid-activated phyllosilicate. It is possible thereby to minimize or avoid harmful effects of such redox reactions on the nucleic acid molecules or other components in the liquid medium. A method for determining the iron content as part of the silicate analysis is indicated in the methods section hereinafter.

In a preferred embodiment of the invention, the layer with the at least one acid-activated phyllosilicate has a layer thickness of more than 0.3 cm, preferably more than 0.5 cm. The layer thickness chosen in the individual case will, as is evident to the skilled worker, depend on the volume of the liquid medium with the at least one nucleic acid molecule and on the concentration of the nucleic acids present in the liquid medium. However, in many cases, the layer thickness will be between about 0.1 and 100 cm.

In a further aspect of the present invention, it has been found that acid-activated phyllosilicates in particulate form with a dry sieve residue of less than 10%, in particular less than 5%, more preferably less than 1%, at 5 μm, in particular at 10 μm, more preferably at 35 μm (using corresponding fine sieves) are particularly advantageously suitable for producing a layer or column packing. The precise preferred particle size in the case of column packing is frequently also influenced by the porosities of the frits used and may in some cases also be between 5 and 10 μm, determined from the dry sieve residue (as indicated above). It has emerged that with such a particle size the permeability of the layer with the acid-activated phyllosilicate is particularly favorable for the preferred aqueous or alcoholic media and, at the same time, makes good sorption of the nucleic acid molecules onto the particulate acid-activated phyllosilicate possible.

In a preferred embodiment of the invention, the acid-activated phyllosilicate has in this connection a swelling capacity of less than 15 ml/2 g, in particular less than 10 ml/2 g. A swelling capacity of about 1 to 15 ml/2 g is more preferred, in particular from 2 to 10 ml/2 g. Such a swelling capacity of the acid-activated phyllosilicate makes it possible to produce layers particularly suitable for the sorption of nucleic acids, e.g. in the form of columns. One method for determining the swelling capacity (of the sediment volume) is indicated hereinafter in the methods section.

In one embodiment of the invention, the products of the weathering of clays having a specific surface area of more than 200 m²/g, a pore volume of more than 0.5 ml/g and a cation exchange capacity of more than 35 meq/100 g in acid-activated form have proved to be useful. Raw clays whose cation exchange capacity are above 40 meq/100 g, preferably in the range from 45 to 85 meq/100 g, are particularly preferred according to this specific embodiment for the acid activation. The specific BET surface area is particularly preferably in the range from 170 to 280 m²/g, in particular between 180 and 260 m²/g. The pore volume is preferably in the range from 0.7 to 1.0 ml/100 g, in particular in the range from 0.80 to 1.0 ml/100 g. The acid activation of such raw clays can be carried out as specified in detail herein. Such clays are described for example in DE 103 56 894.8 of the same applicant, which in this regard is expressly incorporated in the present description by reference.

It has also been found in the context of the present invention that in particular the two-layer and the three-layer phyllosilicates can be used advantageously even without acid activation in the layers for the sorption of nucleic acids and other biomolecules. The smectic phyllosilicates (see above) such as bentonite are particularly preferred in this connection. In a further aspect of the present invention, therefore, it is possible to employ a non-activated phyllosilicate instead of the acid-activated phyllosilicate, or a mixture of the two as sorbent of the invention. Otherwise, the statements made in the present description apply correspondingly in relation to the method and the use of the sorbent.

In a preferred embodiment of the invention, the sorbent employed according to the invention in the layer, or the layer itself is, however, based on at least one acid-activated phyllosilicate, i.e. at least 50% by weight, preferably at least 75% by weight, more preferably at least 90% by weight, in particular at least 95% by weight or even at least 98% by weight of the sorbent or the layer of the invention consist of one (or more) acid-activated phyllosilicate(s) as defined herein. In a preferred embodiment, no silica or silica gel is used. In a further preferred embodiment, the sorbent or the layer of the invention consists essentially or completely of at least one acid-activated phyllosilicate. The sorbent employed according to the invention can, however, also be employed in the layer together with other sorbents appearing suitable to the skilled worker or further components, for example in the context of the method of the invention according to claim 1.

In a preferred embodiment of the invention, the acid-activated phyllosilicate has an average pore diameter determined by the BJH method (DIN 66131) of between about 2 nm and 25 nm, in particular between about 4 and about 10 nm.

In a preferred embodiment of the invention, the pore volume, determined by the CCl₄ method in accordance with the methods section, of pores up to 80 nm in diameter is between about 0.15 and 0.80 ml/g, in particular between about 0.2 and 0.7 ml/g. The corresponding values for pores up to 25 nm in diameter are in the range between about 0.15 and 0.45 ml/g, in particular 0.18 to 0.40 ml/g. The corresponding values for pores up to 14 nm are in the range between about 0.10 and 0.40 ml/g, in particular about 0.12 to 0.37 ml/g. The pore volumes for pores between 14 and 25 nm in diameter may be for example between 0.02 and 0.3 ml/g. The pore volume of pores with 25 to 80 nm can be for example in the same range.

The porosimetry of the acid-activated phyllosilicates can also be influenced deliberately by the conditions during the acid activation of the phyllosilicates, i.e. in particular the amount and concentration of the acid employed, the temperature and the duration of the acid treatment. Thus, for example, a greater porosity of the phyllosilicates can be brought about by a stronger acid activation with an increased amount of acid or at an elevated temperature over a longer period, especially in the range of smaller pores with a diameter of less than 50 nm, in particular less than 10 nm, determined by the CCl₄ method in accordance with the methods section. Thus, the micropore volume of the phyllosilicate can be increased by increasing the amount of acid used for the acid activation. At the same time, the cation exchange capacity declines. It is thus possible to optimize, by routine investigation of a series of differently acid-activated phyllosilicates, the sorption capacity of the acid-activated phyllosilicate for the nucleic acid species of interest in each case, or its rate of absorption and desorption via the acid activation in the individual case. For example, the pores/cavities in the sorbents of the invention can be modified via the acid activation in the manner provided in EP 0 104 210 or U.S. Pat. No. 4,029,583 (see above).

The acid-activated phyllosilicates employed according to the invention are generally prepared by treating phyllosilicates with at least one acid. For this purpose, the phyllosilicates are brought into contact with the acid(s). It is possible in this connection in principle to use any method familiar to the skilled worker for acid activation of phyllosilicates, including the methods described in WO 99/02256, U.S. Pat. No. 5,008,226 and U.S. Pat. No. 5,869,415, which are to this extent expressly included in the description by reference. It is possible to use in general any organic or inorganic acids or mixtures thereof. For example, acid can be sprayed on by a so-called SMBE process (surface modified bleaching earth). The activation in this case takes place on the surface of the phyllosilicates without operating in a solution or dispersion.

In a first embodiment, therefore, the activation of the phyllosilicate is carried out in aqueous phase. For this purpose, the acid is brought into contact, as aqueous solution, with the phyllosilicate. The procedure in this case can be such that initially the phyllosilicate, which is preferably provided in the form of a powder, is slurried in water. Subsequently, the acid (e.g. in concentrated form) is added. However, the phyllosilicate can also be slurried directly in an aqueous solution of the acid, or the aqueous solution of the acid can be put onto the phyllosilicate. In an advantageous embodiment, the aqueous acid solution can for example be sprayed onto a preferably crushed or powdered phyllosilicate, in which case the amount of water is preferably chosen to be as small as possible and, for example, a concentrated acid or acid solution is employed. The amount of acid can preferably be chosen to be between 1 and 10% by weight, particularly preferably between 2 and 6% by weight of an acid, in particular of a strong acid, e.g. of a mineral acid such as sulfuric acid, based on the anhydrous phyllosilicate (absolutely dry). If necessary, excess water can be evaporated off, and the activated phyllosilicate can then be ground to the desired fineness. As already explained above, also in this embodiment of the method of the invention a washing step is unnecessary, but possible. Putting on of the aqueous solution of the acid is merely followed, if necessary, by drying until the desired moisture content is reached. Usually, the water content of the resulting acid-activated phyllosilicate is adjusted to a content of less than 20% by weight, preferably less than 15% by weight.

The acid for the activation described above with an aqueous solution of an acid or of a concentrated acid can be chosen as desired per se. It is possible to use both mineral acids and organic acids or mixtures of the aforementioned acids. Usual mineral acids can be used, such as hydrochloric acid, phosphoric acid or sulfuric acid, with preference for sulfuric acid. It is possible to use concentrated or dilute acids or acid solutions. Organic acids which can be used are solutions of, for example, citric acid or oxalic acid.

A further preferred possibility for activation is represented by boiling the phyllosilicates in an acid, in particular hydrochloric or sulfuric acid. In this case, different degrees of activation can be adjusted by the suitable concentrations of acid and boiling times, and the pore volume distribution can be deliberately adjusted. Such activated phyllosilicates are frequently also referred to as bleaching earths. Drying of the materials is followed by grinding thereof by conventional methods.

In the “classical” activation, which is preferred according to the invention in many cases, activation takes place at temperatures round about 100° C. to the boiling point. By contrast, the SMBE method is normally carried out at room temperature, with elevated temperatures making better acid activations possible in individual cases. The influence of the temperature in the SMBE method is, however, far less than in the “classical” activation (so-called HBPE method). The holdup time (duration of the acid activation) in the HBPE method is for example between about 8 hours, e.g. on use of hydrochloric acid, and 12 to 15 hours, e.g. on use of sulfuric acid. The HBPE method differs from the SMBE method in that the sheet structure is attacked, resulting in regions with silicic acid, in addition to areas of substantially unchanged structure. In the SMBE method, for example, 3% by weight H₂SO₄ are put on (100+3). Analysis of the worked-up material then normally reveals acid contents in the range from 0.4 to 1.0%, i.e. most of the acid is consumed (exchange of H⁺ ions for other cations, etc.). A small portion is consumed where appropriate by lime which is present. In the SMBE method, the contact times with the acid are frequently about 15 minutes in the laboratory.

It has been found that, depending on the phyllosilicate used, activation with small amounts of acid may suffice to obtain surprisingly good sorbents.

In a particularly preferred embodiment of the invention, the phyllosilicate is activated in such a way that the cation exchange capacity (CEC) of the employed acid-activated phyllosilicate is less than 50 meq/100 g, in particular less than 40 meq/100 g. The activation in this case particularly preferably takes place using an at least 1 molar, in particular at least 2 molar acid solution at elevated temperature, in particular at more than 30° C., more preferably more than 60° C. In a further preferred embodiment, an acid with a pKa of less than 4, in particular less than 3, more preferably less than 2.5, is employed for advantageous activation of the phyllosilicates. Examples preferably employed are strong mineral acids, in particular hydrochloric acid, sulfuric acid or nitric acid or mixtures thereof, in particular in concentrated form. The preferred amount of acid is more than 1% by weight, in particular more than 2% by weight, particularly preferably at least 3% by weight of acid, more preferably at least 4% by weight of acid based on the amount of phyllosilicate to be activated (determined after drying at 130° C.). In a particularly preferred embodiment of the invention, the exchangeable (metal) cations (intermediate layer cations) are substantially completely replaced by protons by the acid activation of the phyllosilicate, i.e. to the extent of more than 90%, in particular more than 95%, particularly preferably more than 98%. This can be determined by means of the CEC and the ion contents thereof before and after the acid activation.

In one embodiment, it is unnecessary in the acid activation to wash out the excess acid and the salts formed in the activation. On the contrary, after the acid has been put on, as usual in the acid activation, no washing step is carried out, but the treated phyllosilicate is dried and then ground to the desired particle size.

The sorbent employed according to the invention (acid-activated phyllosilicate) can be employed in the form of a powder, granules or of a shaped article of any shape. In general, the sorbents can be used in any desired form, including supported or immobilized forms. For example, use in the fractionation of different nucleic acid components on the basis of their molecular weight is also conceivable. The form of application of the adsorbents of the invention is in this connection not restricted to the cited examples.

The layer which has the at least one acid-activated phyllosilicate and which is employed according to the invention will in many cases be a layer in a column or cartridge, as normally used for passing through a liquid medium. Possibilities in this connection are for example chromatography columns, inclusive of gravity or centrifugation columns, solid-phase chromatographies, filter cartridges or membranes.

In general, the particle size or size of the shaped article of the acid-activated phyllosilicate used as sorbent according to the invention will therefore depend on the particular application. All particle sizes or agglomerate sizes are possible in this case. For example, the acid-activated phyllosilicate can be employed in powder form, in particular with a D₅₀ of from 1 to 1000 μm, in particular from 5 to 500 μm. Typical useful granules are in the range (D₅₀, volume-based) between 100 μm to 5000 μm, in particular 200 to 2000 μm particle size. However, the dry sieve residues indicated above are particularly preferred for the layers and column packings employed according to the invention. For many applications it is possible advantageously to have recourse to shaped articles made of or having the acid-activated phyllosilicates, for example in chromatography columns, inclusive of gravity or centrifugation columns, solid-phase chromatographies, filter cartridges, membranes, etc.

In a particularly preferred embodiment of the invention it is possible, as mentioned above, for the sorbent employed according to the invention to be in immobilized form. For example, the sorbent can be incorporated in a filter cartridge, an HPLC cartridge or a comparable presentation. Incorporation in gels such as, for example, agarose gels or other gelatinous or matrix-like structures is also preferably possible. Such applications are frequently sold in the framework of so-called kits for purifying nucleic acid molecules, such as, for example, the products of Quiagen, such as Quiagen genomic tip or the like. This generally entails passing the medium containing the nucleic acid molecules of interest through a column or filter cartridge or the like containing the sorbent. It is then possible to wash with suitable buffers in order to remove adherent impurities. This is finally followed by an elution step to recover the nucleic acid molecules of interest.

In a further preferred embodiment of the invention, the acid-activated phyllosilicate has a BET surface area (determined as specified in DIN 66131) of at least 50 to 800 m²/g, in particular at least 100 to 600 m²/g, particularly preferably at least 130 to 500 m²/g. The large surface area evidently facilitates the interaction with the nucleic acid, with the possibility of desorption surprisingly being retained.

In a preferred embodiment of the invention, the nucleic acids are DNA or RNA molecules in double-stranded or single-stranded form with one or more nucleotide building blocks.

In relation to nucleic acids, the method of the invention is particularly advantageous in media which comprise oligonucleotides or nucleic acids having at least 10 bases (base pairs), preferably having at least 100 bases (base pairs), in particular at least 1000 bases (base pairs). The method of the invention can, of course, also be employed for nucleic acids of between 1 and 10 bases (base pairs) or for quite large nucleic acid molecules such as plasmids or vectors having, for example, 1 to 50 kB or longer genomic or cDNA fragments. Likewise included are restriction-digested DNA and RNA fragments, synthetic or natural oligo- and polymers of nucleic acids, cosmids, etc.

An example of interest is the chromatographic separation of biological macromolecules such as long-chain oligonucleotides, high molecular weight nucleic acids, tRNA, 5S-rRNA, other rRNA species, single-stranded DNA, double-stranded DNA (e.g. plasmids or fragments of genomic DNA), etc. It is moreover possible with the method of the invention surprisingly to achieve an improved resolution with high flow rate. The support materials used can moreover be employed in a wide temperature range and show a high loadability. The support material also shows a great resistance to pressure and a long useful life.

There is also an increase in demand for high-purity nucleic acids such as, for example, high-purity plasmid DNA for modern biotechnological but also medical development, such as, for example, in the area of gene therapy. The protocols known in the prior art for purifying nucleic acids to high purity are frequently costly and/or time-consuming, unsuitable for use on the industrial scale or not reliable enough for therapeutic purposes, because toxic solvents or enzymes of animal origin such as, for example, RNAse are used.

Liquid medium means according to the invention any non-solid medium, inclusive of low- or high-viscosity and fluid media. Preferred media will be polar media in which the biomolecules or nucleic acid molecules of interest are ordinarily present. Possible examples are a colloidal solution, a suspension, a dispersion, a solution or emulsion.

The particularly preferred aqueous or alcoholic media mean according to the invention all water- or alcohol-containing media, including aqueous-alcoholic media. Generally included are also all media in which water is completely miscible or completely mixed with other solvents. Mention should be made in particular of alcohols such as methanol, ethanol and C₃ to C₁₀ alcohols having one or more OH groups or else acids. Also conceivable are thus solvents completely miscible with water, and mixtures thereof with water and alcohol. In practice, these are in particular aqueous, aqueous-alcoholic or alcoholic media.

Typical examples are aqueous or alcoholic buffer systems like those used in science and industry, industrial or non-industrial wastewaters, process waters, fermentation residues or media, media from medical or biological research, liquid or fluid contaminated sites and the like.

The sorbent of the invention may comprise further components in the layer, as long as this does not impair unacceptably the adsorption of the nucleic acids and, where intended, also the desorption thereof. Such additional components may include, without being restricted thereto, organic or inorganic binders (see below), further sorbents familiar to the skilled worker for biomolecules or other inorganic or organic substances of interest from the medium, or else support materials such as glass, plastics or ceramic materials or the like.

Thus, in an advantageous embodiment of the invention, the sorbent particles in the layer employed can be combined with a suitable binder to give larger agglomerates, granules or shaped articles or applied to a support. The shape and size of such superordinate structures which comprise the primary sorbent particles or phyllosilicate particles depends on the desired application in each case. It is thus possible to employ all shapes and sizes which are familiar to the skilled worker and suitable in the individual case. For example, in many cases agglomerates having a diameter of more than 10 μm, in particular more than 50 μm, may be preferred. Moreover, a spherical shape of the agglomerates may be advantageous for a packing for chromatography columns and the like. Examples of possible supports are calcium carbonate, plastics or ceramic materials.

It is also possible to use any binder familiar to the skilled worker as long as it does not too greatly impair the deposition or infiltration of the biomolecules into or onto the sorbent in the layer, and the stability, to be required for the particular application, of the particle agglomerates or shaped articles is ensured. Examples of binders which can be used, without restriction thereto, are: agar-agar, alginates, chitosans, pectins, gelatins, lupin protein isolates or gluten.

As already stated above, it has surprisingly been found in one aspect of the invention that the acid-activated phyllosilicates themselves provide particularly favorable surfaces for the sorption of nucleic acids. It is thus preferred according to the invention for no (additional) use or treatment of the phyllosilicate with cationic polymers and/or polycations (multivalent cations) to take place. It is further preferred according to the invention for no other polymers (e.g. polysaccharides), polyelectrolytes, polyanions and/or complexing agents (for modifying the phyllosilicate) to be used. In a particularly preferred embodiment of the invention, in particular no cationic polymer such as, for example, an aminated polysaccharide polymer or polycation is employed. In particular, in a further preferred embodiment of the invention, the acid-activated phyllosilicate used according to the invention is not modified or treated with a (cationic) polymer or a polycation.

The method of the invention can be utilized both for enrichment (i.e. increasing the concentration of the desired nucleic acid molecule(s)) and depletion (i.e. reduction in the concentration of the desired nucleic acid molecule(s)) or fractionation of a plurality of different nucleic acid molecules.

If the method of the invention is intended to remove or dispose of nucleic acid molecules, it is possible in a further step to dispose of the layer comprising the nucleic acid molecules. The disposal can in this case take place for example by thermal treatment to remove the phyllosilicate comprising the biomolecules, in which case the phyllosilicate can be disposed of after the thermal disintegration of the nucleic acid molecules.

It is thus possible in a first aspect of the invention to remove nucleic acids deliberately from media. This plays a great part for example in wastewater treatment because in this connection strict legal regulations exist in most countries concerning the removal of nucleic acids and other biomolecules from wastewaters.

In a further preferred embodiment of the invention, it is also possible to carry out the depletion or removal of nucleic acid molecules from culture media. Thus, for example in bioreactors, it is possible for an unwanted increase in the viscosity to occur owing to the high concentration of nucleic acid molecules, in particular high molecular weight nucleic acids, present in the medium. In this case it is possible by the method of the invention to remove the interfering nucleic acid molecules from the culture medium in an efficient and biocompatible manner.

It is likewise desired in many cases to increase the concentration of nucleic acid molecules in a medium or to recover these nucleic acid molecules in pure form if possible. For example, the recovery or purification of desired nucleic acids from solutions is one of the standard procedures in biological and medical research. It is moreover possible according to the invention in a further step for the nucleic acid molecule to be desorbed or recovered again from the sorbent in the layer, making it possible for the layer also to be employed anew, where appropriate after renewed acid activation of the phyllosilicate present therein.

In a preferred embodiment of the invention, the sorption of the at least one nucleic acid molecule in the layer with the acid-activated phyllosilicate can be followed by at least one washing step. It is possible in this case to use a customary aqueous or alcohol-containing buffer in order to remove impurities which have accumulated in addition to the nucleic acid molecules in the layer. A non-restrictive example of a suitable buffer is 50 mM citrate buffer (pH 4.0).

In the context of the present invention it has also unexpectedly been found that the acid-activated phyllosilicates exhibit a high binding capacity for nucleic acid molecules over a very wide pH range. It is thus advantageously possible to pass liquid media with both acidic and basic pH through the layer with the acid-activated phyllosilicate for sorption of the nucleic acid molecules present therein. In a preferred embodiment of the invention, the liquid medium is passed through, and the sorption of the nucleic acid molecule takes place, in the layer at a pH between about pH 3 and pH 8, in particular between about pH 6 and pH 8. These conditions can easily be provided by adjusting the pH of the liquid medium. The advantageous binding of the nucleic acid molecules to the layer with the acid-activated phyllosilicate over a wide pH range can, in a further aspect of the invention, also be utilized to separate a nucleic acid molecule from, for example, protein constituents which are likewise present in the liquid medium. Thus, after the liquid medium (containing the nucleic acid molecule) has been passed through, the layer can be washed with a series of buffers adjusted to different pH values, or a pH gradient buffer, in order to detach from the layer, and wash out, proteins with different isoelectric points. If the protein impurities to be expected are known, it is also possible by means of preliminary tests to determine the pH at which these protein impurities (usually depending on their isoelectric point) show the least sorption on the acid-activated phyllosilicate.

A further aspect of the present invention relates to a composition in layer form comprising at least one acid-activated phyllosilicate and at least one nucleic acid molecule, where the layer thickness is at least one millimeter. As stated herein, such a compositions in layer form can advantageously be used for example for the separation, recovery or purification of a nucleic acid molecule from a liquid medium.

As stated above, a little iron impurity in the acid-activated phyllosilicate employed is advantageous. A further aspect of the present invention thus also relates to the use of an acid-activated phyllosilicate with a little iron impurity as defined above for the sorption, in particular for removing, recovering or purifying a nucleic acid molecule from a liquid medium. A further aspect relates to the use of such an acid-activated phyllosilicate as inorganic vector for introducing biomolecules into cells or as pharmaceutical composition, in particular as reservoir for storage and controlled release of biomolecules, preferably nucleic acids.

It has thus been found, surprisingly, that the sorbents of the invention are also suitable for efficient insertion of these biomolecules into prokaryotic or eukaryotic cells. It is evidently possible in the method of the invention for biomolecules, in particular nucleic acids, to be “packaged” in a particularly advantageous manner for insertion into cells. The principal mechanism of such an insertion for the example of DNA-LDH nanohybrids is described for example in the reference Choy et al., Angew. Chem. 2000, 112 (22), pages 4207-4211, and in EP 0 987 328 A2, to which reference is made in this regard and which is hereby included in the description by reference in relation to the method. The use as pharmaceutical composition, in particular as reservoir for the storage and controlled release of biomolecules, preferably of nucleic acids, is described as such in WO 01/49869, to which reference is made in this regard and which is hereby included in the description by reference.

### Methods Section

### 1. BET Surface Area

The BET surface areas indicated herein were determined as specified in DIN 66131.

### 2. Porosimetry

The indicated (average) pore diameters, volumes and areas were determined by using a completely automatic nitrogen adsorption-measuring apparatus (ASAP 2000, from Micrometrics) according to the manufacturer's standard program (BET, BJH, t-plot and DFT). The percentage data on the proportion of determined pore sizes relate to the total pore volume of pores between 1.7 and 300 nm in diameter (BJH Adsorption Pore Distribution Report).

Where indicated, the porosimetry was carried out by the CCl₄ method as follows:

### Reagents:

### Tetrachloromethane (CCl₄)

Paraffin (liquid), from Merck, (order no. 7160.2500)

### Procedure:

1 to 2 g of the material to be tested are dried in a small weighing bottle in a drying oven at 130° C. The bottle is then cooled in a desiccator, weighed accurately and placed in a vacuum desiccator which contains the following paraffin/tetrachloromethane mixing ratios depending on the micropore volume to be measured:

| Paraffin (ml) | CCl₄ (ml) | Micropores (Å) |
|---|---|---|
| 26 | 184 | 800 |
| 47.9 | 162.1 | 390 |
| 66.5 | 143.5 | 250 |
| 82.5 | 127.5 | 180 |
| 96.4 | 113.6 | 140 |
| 108.7 | 101.3 | 115 |

The desiccator is connected to a graduated cold trap, manometer and vacuum pump and then evacuated until the contents boil. 10 ml of tetrachloromethane are evaporated and collected in the cold trap.

The contents of the desiccator are then allowed to equilibrate at room temperature for 16 to 20 hours, and subsequently air is slowly allowed into the desiccator. After removal of the desiccator lid, the weighing bottle is immediately closed and reweighed on an analytical balance.

### Evaluation:

The values are calculated in milligrams of tetrachloromethane adsorbed per gram of substance through the weight gain. Division by the density of tetrachloromethane results in the
pore volume in ml/g of substance.

$$Final weight - initial weight = \frac{weight gain}{\begin{matrix}g of substance \times initial weight \times \\ density of {CCl}_{4}\end{matrix}} \\ = ml \text{/} g of substance .$$

(Tetrachloromethane at 20° C., d=1.595 g/cm³)

### 3. Measurement of the Zeta Potential

An aqueous suspension of each of the adsorbents to be investigated was prepared with dist. water. The suspension to be measured was in each case adjusted to pH 7. The zeta potential of the particles was determined according to the principle of microelectrophoresis using the Zetaphoremeter II supplied by Particle Metrix. This entailed measurement of the rate of migration of the particles in a known electric field. The particle movements taking place in a measuring cell are observed with the aid of a microscope. The direction of migration provides information about the nature of the charge (positive or negative) and the particle velocity is directly proportional to the electrical interface charge of the particles or to the zeta potential. The particle movements in the measuring cell are ascertained by means of image analysis and, after completion of the measurement, the particle paths covered are calculated and the particle velocity resulting therefrom is ascertained.

The zeta potential (stated in mV) was calculated therefrom, taking account of the suspension temperature and the electrical conductivity.

It was surprisingly found in the context of the present invention that good results can also be achieved with phyllosilicates having negative zeta potential.

### 4. Determination of the Particle Sizes and Particle Size Distribution

Unless indicated otherwise, the Malvern method is used to determine the particle size (distribution). A Malvern Mastersizer was employed in accordance with the manufacturer's instructions for this purpose. For air determination, about 2-3 g (1 coffee spoonful) of the sample to be investigated are put in the dry powder feeder and adjusted to the correct measurement range depending on the sample (a larger weight for a coarser sample).

For determination in water, a sample (about 1 knifetipful) is put into the water bath until the measurement range is reached (a larger weight for greater coarseness) and agitated in an ultrasound bath for 5 min. The measurement then takes place.

### 5. Cation Exchange Capacity (CEC)

Principle: The clay is treated with a large excess of aqueous NH₄Cl solution and thoroughly washed, and the amount of NH₄⁺ remaining on the clay is determined by elemental analysis.

Me⁺(clay)⁻+NH₄⁺—NH₄⁺(clay)⁻+Me⁺
(Me⁺=H⁺, K⁺, Na⁺, 1/2 Ca²⁺, 1/2 Mg²⁺ . . . . )

Apparatus: sieve, 63 μm; ground-joint Erlenmeyer flask, 300 ml; analytical balance; membrane filter funnel, 400 ml; cellulose nitrate filters, 0.15 μm (from Sartorius); drying oven; reflux condenser; hotplate; distillation unit, VAPODEST-5 (from Gerhardt, no. 6550); graduated flasks, 250 ml; flame AAS

Chemicals: 2N NH₄Cl solution; Nessler's reagent (from Merck, cat. no. 9028); boric acid solution, 2% strength; sodium hydroxide solution, 32% strength; 0.1 N hydrochloric acid; NaCl solution, 0.1% strength; KCl solution, 0.1% strength.

Procedure: 5 g of clay are sieved through a 63 μm sieve and dried at 110° C. Then exactly 2 g are weighed by differential weighing on the analytical balance into the ground-joint Erlenmeyer flask, and 100 ml of 2N NH₄Cl solution are added. The suspension is boiled under reflux for one hour. Ammonia may be evolved with bentonites having a high CaCO₃ content. It is necessary in these cases to add NH₄Cl solution until the odor of ammonia is no longer perceptible. An additional check can be carried out with a moist indicator paper. After standing for about 16 h, the NH₄⁺ bentonite is filtered off on a membrane filter funnel and washed with deionized water until substantially free of ions (about 800 ml). The washings are demonstrated to be free of ions by using Nessler's reagent which is sensitive for NH₄⁺ ions. The number of washes may vary depending on the type of clay between 30 minutes and 3 days. The thoroughly washed NH₄⁺ clay is removed from the filter, dried at 110° C. for 2 h, ground, sieved (63 μm sieve) and again dried at 110° C. for 2 h. The NH₄⁺ content of the clay is then determined by elemental analysis.

Calculation of the CEC: The CEC of the clay was determined in a conventional manner via the NH₄⁺ content of the NH₄⁺ clay which was ascertained by elemental analysis of the N content. The apparatus used for this was the Vario EL 3 from Elementar-Heraeus, Hanau, Del., in accordance with the manufacturer's instructions. Data are given in meq/100 g of clay (meq/100 g).

Example: nitrogen content=0.93%;
Molecular weight: N=14.0067 g/mol

$$CEC = \frac{0.93 \times 1000}{14.0067} \\ = 66.4 meq / 100 g$$

CEC=66.4 meq/100 g of NH₄⁺ bentonite

### 6. Swelling Capacity (Sediment Volume)

The swelling capacity was determined as follows: A calibrated 100 ml graduated cylinder is filled with 100 ml of dist. water. 2.0 g of the substance to be measured are put in portions of from 0.1 to 0.2 g slowly onto the water surface. After the material has sunk, the next quantum is added. One hour is allowed to elapse after completion of the addition, and then the volume of the swollen substance is read off in ml/2 g.

### 7. Silicate Analysis:

### (a) Sample Digestion

This analysis is based on total digestion of the phyllosilicate. After the solids have dissolved, the individual components are analyzed and quantified by conventional specific analytical methods such as, for example, ICB.

For the sample digestion, about 10 g of the sample to be investigated are finely ground and dried to constant weight in a drying oven at 120° C. for 2 hours. About 1.4 g of the dried sample are put into a platinum crucible, and the initial weight of the sample is determined to an accuracy of 0.001 g. The sample is then mixed in the platinum crucible with 4 to 6 times the amount by weight of a mixture of sodium carbonate and potassium carbonate (1:1). The mixture with the platinum crucible is placed in a Simon-Müller furnace and melted at 800-850° C. for 2-3 hours. The platinum crucible with the melt is removed from the furnace with platinum tongs and left to stand in order to cool. The cooled melt is rinsed with a little distilled water into a casserole, and concentrated hydrochloric acid is cautiously added. After gas evolution ceases, the solution is evaporated to dryness. The residue is again taken up in 20 ml of conc. hydrochloric acid and again evaporated to dryness. The evaporation with hydrochloric acid is repeated once more. The residue is moistened with about 5-10 ml of hydrochloric acid (12%), mixed with about 100 ml of distilled water and heated. Insoluble SiO₂ is filtered off, and the residue is washed three times with hot hydrochloric acid (12%) and then washed with hot water (dist.) until the filtrate water is chloride-free.

### (b) Silicate Determination

The SiO₂ is ashed with the filter and weighed.

### (c) Determination of Iron (and Aluminum, Calcium and Magnesium)

The filtrate collected in the silicate determination is transferred into a 500 ml graduated flask and made up to the calibration mark with distilled water. FAAS is then carried out on this solution to determine iron (and also for aluminium, calcium and magnesium).

### (d) Determination of Potassium, Sodium and Lithium

500 mg of the dried sample are weighed accurate to 0.1 mg into a platinum dish. The sample is then moistened with about 1-2 ml of dist. water, and 4 drops of concentrated sulfuric acid are added. The mixture is then evaporated to dryness with about 10-20 ml of conc. HF in a sand bath three times. It is finally moistened with H₂SO₄ and evaporated to dryness on a hotplate. After the platinum dish has been briefly heated to red heat, about 40 ml of dist. water and 5 ml of hydrochloric acid (18%) are added, and the mixture is boiled. The resulting solution is transferred into a 250 ml graduated flask and made up to the calibration mark with dist. water. The sodium, potassium and lithium content of this solution is determined by EAS.

### 8. DNA Quantification by Fluorescence Labeling

The DNA content of solutions employed for the adsorption investigations in a dynamic system was determined by employing the method of fluorescence photometric quantification of DNA using the fluorescent marker Hoechst 33342 (2′-(4-ethoxyphenyl)-5-(4-methyl-1-piperazinyl)-2,5′-bi-1H-benzimidazole.3HCl) (from Sigma, Steinheim).

This is based on the non-intercalative binding of the dye to the adenine-thymine base pair of the DNA. The fluorescence intensity of the fluorochrome is multiplied by a factor of 60 through its binding to the DNA. The position of the maximum excitation and emission wavelengths of unbound Hoechst dye shifts from 340 nm and 510 nm to 355 nm and 465 nm for dye bound to DNA. The fluorescence intensity of a sample incubated with the fluorochrome can be determined with a fluorescence photometer. Since the wavelength of the excitation and emission maxima of the fluorochrome shift on addition onto the DNA, the bound dye can be selectively excited, thus avoiding a strong background signal.

The following stock solutions were employed for this method:

Hoechst-33342 stock solution: 10 mg·ml-1 Hoechst 33342 in ddH2O
1×TNE buffer: 10 mM Tris, 1 mM EDTA, 0.2 M NaCl in 1000 ml ddH2O, pH 7.4)

A calibration line for the fluorescence photometric determination of the DNA concentration was then constructed as follows:
In each case 10 μl of sample and a standard series with DNA concentrations from 100 μg·ml⁻¹ to 4750 μg·ml⁻¹ are applied in triplicate to a black 96-well plate (Nunc, Roskilde, Denmark).
The samples are mixed with 200 μl of a mixture of 100 μl of Hoechst-33342 stock solution with 20 ml of 1×TNE buffer (10 mM Tris, 1 mM EDTA, 0.2 M NaCl in 1000 ml ddH₂O, pH 7.4).
The samples are incubated while shaking at 120 rpm with exclusion of light for 30 min.
The fluorescence intensity of the samples is measured by excitation at 360 nm and detection at 460 nm in a fluorescence photometer.
The procedure for the DNA-containing solutions on investigation of the DNA binding to the acid-activated bentonites in the dynamic systems was analogous to that described in the last section. The previously constructed calibration line was used in this case to determine the DNA contents.

The invention is explained in more detail below by means of non-restrictive examples.

The figures show:

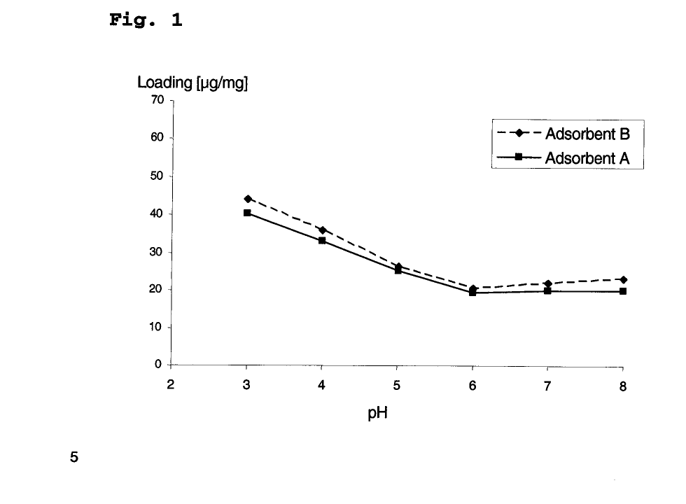

FIG. 1 shows the DNA loading of adsorbents A and B of the invention at various pH values

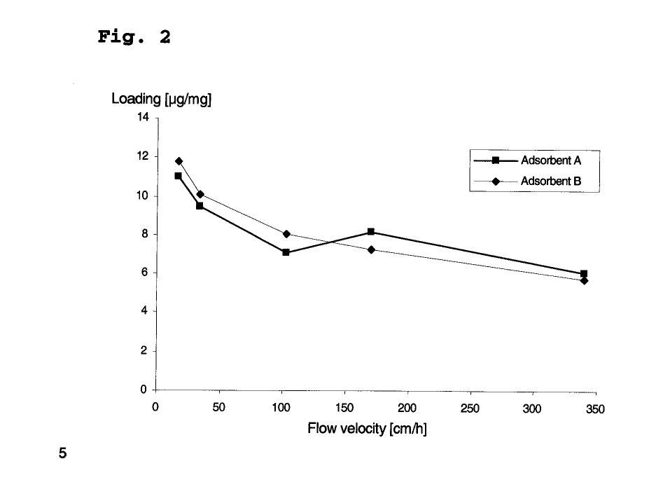

FIG. 2 shows the DNA loading of adsorbents A and B of the invention with various flow rates through a column packing.

### EXAMPLES

### 1. Preparation of a Sorbent

A raw clay with a montmorillonite content of between 70 to 80% is slurried in water and purified by centrifugation. The resulting slurry is then subjected to an acid activation. This entails the concentrations being adjusted so that 56% bentonite is mixed with 44% 36% by weight hydrochloric acid and boiled at a temperature of 95 to 99° C. for 8 hours. This is followed by washing with water until the residual chloride content is less than or equal to 5% based on the solid. To analyze the residual chloride content, 10 g of solid are boiled in 100 ml of distilled water and filtered through a fluted filter. The filtrate is titrated against silver nitrate solution to determine the residual chloride content. Finally, drying takes place until the residual moisture content is 8 to 10% by weight. The resulting final product has a weight of 430 to 520 g/l. Particularly preferred particle sizes can be adjusted by screening or additional grinding.

### 2. Characterization of the Sorbent

The characteristic data of this sorbent (adsorbent 1) and of the corresponding degree of grinding are listed in the following tables. Characterization of the surface shows that a negative zeta potential is present in solutions. The surface charge density is, however, relatively small. Values above 200 μeq/g can be achieved here with specially modified materials.

TABLE 1
Surface charge density and zeta potential

| | Surface charge | Zeta |
|---|---|---|
| | density in | potential |
| Sample | [μeq/g] | [mV] |
| Adsorbent 1 | −31 | −46.5 |

TABLE 2
Particle size distribution

| | Particle size distribution | | Particle size distribution | |
|---|---|---|---|---|
| | in air | | in water | |
| Sample | μm | [%] | μm | [%] |
| Adsorbent 1 | >25 | 4.13 | >25 | 5.41 |
| | >20 | 6.14 | >20 | 9.15 |
| | >10 | 18.56 | >10 | 30.00 |
| | <5 | 57.42 | <5 | 38.42 |
| | <2 | 27.57 | <2 | 7.61 |
| | <1 | 10.79 | <1 | 0.87 |

Adsorbent 1 was characterized by the BJH method and BET method (DIN 66131) for the average pore diameter and the BET surface area. The following values resulted:

TABLE 3
BET surface area and pore diameter

| Characteristic data | Value | |
|---|---|---|
| BET surface area | 270 | m²/g |
| Average pore diameter 4V/A BET | 5.7 | nm |
| Average pore diameter 4V/A BJH | 5.9 | nm |
| BJH: Cumulative pore volume for pores | 0.42 | cm³/g |
| from 1.7 to 300 nm | | |

The values resulting from the CCl₄ method (cf. above) were as follows:

TABLE 4
Pore diameter and pore volume

| Range of pore diameters (nm) | Pore volume (ml/g) |
|---|---|
| 0-14 | 0.279 |
| 14-25 | 0.032 |
| 25-80 | 0.034 |

In order to test the suitability of the novel type of adsorbent for binding DNA, adsorption experiments were carried out with herring sperm DNA (Aldrich).

To determine the concentration in the adsorption experiments, the DNA concentration was determined by photometry. A wavelength of 260 nm was set for the measurement in this case. The method was calibrated by carrying out a measurement with a series of concentrations of the DNA salt employed. The resulting calibration line was employed for photometric determination of the DNA concentration in the adsorption experiments.

For the adsorption experiments, a herring sperm DNA solution with a concentration of 1 mg/ml, 2 mg/ml, 5.63 mg/ml and 9.9 mg/l was prepared and adjusted to pH 8 with 10 mM Tris/HCl and 1 mM EDTA. Then, 0.1 g of the adsorbents was in each case mixed with 5 ml of the DNA solution and shaken at room temperature for 1 hour. This was followed by centrifugation at 2500 rpm for 15 minutes, and the supernatant was sterilized by filtration. Finally, the DNA concentration in the supernatant was measured and the DNA binding capacity was calculated therefrom. The results are compiled in the following table and in the following graph:

TABLE 5
DNA binding capacities

| DNA solution [mg/ml] | 1 | 2 | 5.63 | 9.87 |
|---|---|---|---|---|
| BC (adsorbent 1) | 11 | 30 | 116.5 | 133.5 |
| [mg DNA/g adsorbent] | | | | |

BC = Binding capacity → calculated in mg of DNA based on 1 g of the adsorbents

The bound DNA was recovered from the adsorbents by eluting with 1.5 molar sodium chloride solution in 10 mM Tris HCL pH 8.5 for 1 h (elution volume: 100 ml), centrifuging at 2500 rpm for 15 min, sterilizing the supernatant by filtration and measuring the absorption.

TABLE 4
Elution of the bound DNA

| | | | Recovery rate in % |
|---|---|---|---|
| Concentration on | | DNA recovered | of the previously bound |
| loaded adsorbent 1 | | in the eluate | DNA |
| 1 | mg/ml | 10.06 mg/g | 91.4% |
| 10 | mg/ml | 123.5 mg/g | 92.4% |

It was found in this case that the bound DNA can be recovered again virtually quantitatively from the adsorbents. This shows the potential use of the novel adsorbents both for separating and for purifying DNA.

In order to be able to categorize the DNA binding capacity of the adsorbents of the invention compared with the prior art, analogous binding tests were carried out with a commercially available anion exchanger (Quiagen®, genomic Tip). The matrix was removed from the column and ground to a particle size comparable to the material of the invention. The comparative results are listed in the table below.

TABLE 5
Comparative results on the DNA binding capacity
with commercially available adsorbent

| | Binding capacity in mg · g⁻¹ |
|---|---|
| Adsorbent | after 16 h with 2.5 mg/ml DNA |
| Weakly basic anion | 12.6 |
| exchanger (Quiagen ®) | |

As comparison of table 3 and table 4 shows, the binding capacity of the adsorbent type of the invention is considerably higher than that of the comparative anion exchanger. The binding capacities of adsorbents commercially available according to the prior art are thus reached or exceeded. An additional factor is that the adsorbents of the invention display substantially faster DNA binding, because the corresponding amounts of DNA are bound after only 1 hour compared with the adsorption time of 16 hours with the comparative material.

The data suggest that the binding sites of the adsorbents of the invention are substantially better accessible, especially for large biomolecules, than for the comparative adsorbent.

### 2. Preparation of Further Sorbents (According to the Invention)

Two further raw clays with a montmorillonite content of between 70 to 80% were activated with acid in analogy to the method described in section 1. The final products were dried to a residual moisture content of from 8 to 10% by weight. The resulting final products had apparent densities of between 460 to 510 g/l. Particularly preferred particle sizes can be adjusted by sieving or additional grinding. Materials with dry sieve residues of more than 90% at 5, 10 and 35 μM were used.

### Characterization of the Sorbents

The characteristic data of the above sorbents (adsorbent A and B) are listed in the following tables.

TABLE 6
Surface charge density and zeta potential

| | Zeta |
|---|---|
| | potential |
| Sample | [mV] |
| Adsorbent A | −56.8 |
| Adsorbent B | −60.5 |

Adsorbents A and B were characterized by the BJH method and BET method (DIN 66131) for the average pore diameter and the BET surface area. The following values resulted:

TABLE 7
BET surface area and pore diameter

| | | |
|---|---|---|
| Characteristic data | Adsorbent A | Adsorbent B |

| | | | | |
|---|---|---|---|---|
| BET surface area | 331 | m²/g | 234 | m²/g |
| Average pore diameter 4V/A BET | 6.1 | nm | 6.0 | nm |
| Average pore diameter 4V/A BJH | 6.2 | nm | 6.2 | nm |
| BJH: Cumulative pore volume for | 0.54 | cm³/g | 0.38 | cm³/g |
| pores from 1.7 to 300 nm | | | | |

The values resulting from the CCl₄ method (cf. above) were as follows:

TABLE 8
Pore diameter and pore volume

| Range of pore | Pore volume (ml/g) | Pore volume (ml/g) |
|---|---|---|
| diameters (nm) | Adsorbent A | Adsorbent B |
| 0-14 | 0.32 | 0.23 |
| 0-25 | 0.37 | 0.25 |
| 0-80 | 0.41 | 0.29 |

The results of the silicate analysis were as follows:

TABLE 9
Silcate analysis

| | Adsorbent A | Adsorbent B |
|---|---|---|
| SiO₂ [%] | 75.5 | 66.8 |
| Al₂O₃ [%] | 12 | 14.2 |
| Fe₂O₃ [%] | 2.4 | 3.7 |
| CaO [%] | 0.4 | 1.1 |
| MgO [%] | 1.4 | 2.3 |
| Na₂O [%] | 0.3 | 0.8 |
| K₂O [%] | 1 | 2.2 |

It was possible to demonstrate that the two adsorbents A and B had a comparable DNA binding capacity as described above for adsorbent 1. Investigation of the DNA binding capacity at various pH values (pH 3 to pH 8) revealed a good DNA loading over the entire pH range, as depicted in FIG. 1.

### Investigation of the DNA Binding on a Layer of the Sorbent (in a Dynamic System)

In order to test the suitability of the sorbents for DNA binding or removal in the method of the invention, the materials of adsorbent A and adsorbent B were packed into a chromatography column (15×50 mm with 10 μm PTEE frits) and loaded with DNA at various flow rates (DNA sodium salt from herring sperm, Sigma D6898). The columns were specifically packed as follows: 1000 mg of the adsorbent (A or B) were slurried with 5 ml of 50 mM citrate buffer (pH 4.0) in a 15 ml Falcon tube and pipetted into the column which was closed at the bottom by a plunger. The second column end piece is fitted on, and the column is connected to an FPLC system in such a way that the mobile phase flows upward through it. The FPLC pump is adjusted to the flow rate for which the capacity of the adsorbent is to be ascertained. The movable plunger of the column is slowly made hand-tight during the equilibration with 50 ml of 50 mM citrate buffer (pH 4.0) and is then loosened by a quarter turn.

The column was loaded with DNA by pumping in each case 25 ml of a DNA solution with a DNA concentration of 1 mg/ml in 50 mM citrate buffer (pH 4) by means of an FPLC pump through the columns packed with 1000 mg of adsorbent A or B.

Capacities were determined for flow rates of 0.5, 1, 3, 5 and 10 ml/min. The DNA content of the flow-through was determined by fluorescence photometry by the method described in the methods section by labeling with the fluorescent dye Hoechst 33342 (from Sigma, Steinheim). The difference in the amounts of DNA in the flow-through and the loaded solution is assumed to be bound to the adsorbent. Division of this difference by the mass of adsorbent employed results in its loading at the relevant flow rate. The measurements for adsorbent A and B are depicted as averages of a duplicate determination in FIG. 2. The flow rate was converted into the flow velocity with the unit cm/h using the cross-sectional area of the column. The capacities determined under the stated experimental conditions were over 12 μg/mg¹ for a flow velocity of 16.8 cm/h both adsorbents.

According to the manufacturer's statements, the weakly basic anion exchanger (Genomic Tip) of Qiagen has a dynamic capacity of 0.2 μg·mg-1 for genomic DNA.

### Elution of the Bound DNA

The following buffer was used to elute the DNA bound to the adsorbents. All chromatography steps were carried out at a flow rate of 1 ml/min.

Elution buffer: 50 mM Tris in ddH₂O, pH 8.0

1000 mg of adsorbent A were loaded in flow-through operation (see above) with 25 ml of a DNA solution with a concentration of 1 mg/ml in 50 mM citrate buffer of pH 4. The column was washed with 20 ml of 50 mM citrate buffer (pH 4). The DNA was eluted with 30 ml of elution buffer. The DNA content of the flow-through, of the washing fraction and of the eluted fraction was determined. The results are indicated in table 10 below as averages of a duplicate determination.

TABLE 10

| | Flow-through | Washing fraction | Eluted fraction |
|---|---|---|---|
| DNA content | 13.7 | 1.8 | 8.1 |
| [mg] | | | |

Thus, the recovery rate in the eluate, expressed as % of the DNA loading, is more than 85%.

1. A method for the sorption of at least one nucleic acid molecule from a liquid medium, comprising the following steps:
a. providing a liquid medium comprising at least one nucleic acid molecule;
b. providing a layer comprising at least one acid-activated phyllosilicate, where the layer is permeable by the liquid medium, and the layer thickness is at least 1 mm;
c. passing the liquid medium with the at least one nucleic acid molecule from step a. through the layer from step b. for sorption of the at least one nucleic acid molecule in the layer.

2. The method as claimed in claim 1, characterized in that the acid-activated phyllosilicate has an iron content, calculated as Fe₂O₃, based on the total amount of acid-activated phyllosilicate employed, of less than 6% by weight.

3. The method as claimed in claim 1, characterized in that the layer thickness of the layer according to claim 1, step b., is more than 0.3 cm.

4. The method as claimed in claim 1, characterized in that the acid-activated phyllosilicate has a swelling capacity of not more than 15 ml/2 g.

5. The method as claimed in claim 1, characterized in that the acid-activated phyllosilicate is employed in particulate form with a dry sieve residue of less than 10%.

6. The method as claimed in claim 1, characterized in that the liquid medium comprises an aqueous or alcoholic medium.

7. The method as claimed in claim 1, characterized in that the phyllosilicate is selected from the group consisting of natural or synthetic phyllosilicates.

8. The method as claimed in claim 1, characterized in that the phyllosilicate is not treated with a cationic polymer or polycation.

9. The method as claimed in claim 1, characterized in that the cation exchange capacity of the acid-activated phyllosilicate is less than 70 meq/100 g.

10. The method as claimed in claim 1, characterized in that the acid-activated phyllosilicate has a BET surface area of at least 50 m²/g.

11. The method as claimed in claim 1, characterized in that the acid-activated phyllosilicate, is preferably present in granule form, with a particle size (D50) of from 100 to 500 μm.

12. The method as claimed in claim 1, characterized in that the acid-activated phyllosilicate has a porosimetry as follows: pores up to 80 nm diameter between about 0.15 and 0.80 ml/g; pores up to 25 nm diameter between about 0.15 and 0.45 ml/g; pores up to 14 nm between about 0.10 and 0.40 ml/g, in each case determined by the CCl₄ method.

13. The method as claimed in claim 1, characterized in that the average pore diameter by the BJH method of the acid-activated phyllosilicate is between 2 and 25 nm.

14. The method as claimed in claim 1, characterized in that the at least one nucleic acid molecule is selected from the group consisting of mono-, oligo- and polynucleotides and mixtures thereof.

15. The method as claimed in claim 1, characterized in that the at least one nucleic acid molecule is selected from the group consisting of ribonucleic acids (RNA) and deoxyribonucleic acids (DNA) and mixtures thereof.

16. The method as claimed in claim 1, characterized in that the at least one nucleic acid molecule has at least 10 nucleotide building blocks.

17. The method as claimed in claim 6, characterized in that the preferably aqueous or alcoholic medium with the at least one nucleic acid molecule is selected from the group consisting of a colloidal solution, suspension, dispersion, solution or emulsion.

18. The method as claimed in claim 1 further comprising washing, the layer with the sorbed nucleic acid molecule after step c. with an aqueous or alcoholic buffer in order to remove impurities.

19. The method as claimed in claim 1 further comprising removing or desorbing the at least one nucleic acid molecule from the layer, and recovering the nucleic acid molecule.

20. The method as claimed in claim 1 further comprising disposing of the layer together with the nucleic acid molecule in a further step.

21. The method as claimed in claim 1, characterized in that the layer consists essentially of at least one acid-activated phyllosilicate.

22. The method as claimed in claim 19, characterized in that the desorption or removal of the at least one nucleic acid molecule takes place in an alkaline (pH 8 or more) buffer solution, preferably with more than 1 M NaCl.

23. The method as claimed in claim 1, characterized in that the at least one acid-activated phyllosilicate in the layer is combined with a binder to give particle aggregates or shaped articles or is applied to a support.

24. The method as claimed in claim 23, characterized in that the binder is selected from the group consisting of alginate, agar-agar, chitosans, pectins, gelatin, lupin protein isolates and gluten.

25. A composition in layer form comprising at least one acid-activated phyllosilicate and at least one nucleic acid molecule, where the layer thickness is at least 1 mm.

26. (canceled)

27. (canceled)

28. The method as claimed in claim 19 further comprising employing the layer anew for the sorption of at least one nucleic acid molecule.

29. The method as claimed in claim 1 wherein the liquid medium comprises protein constituents in addition to the at least one nucleic acid molecule and wherein the method is used for separating the at least one nucleic acid molecule from the protein constituents in the liquid medium.
